(19) United States
(12) Patent Application Publication
(10) Pub. No.: US 2023/0030003 A1
(43) Pub. Date: Feb. 2, 2023

(54) BATTERY MODULE WITH THERMAL ENERGY STORAGE MEMBER

(71) Applicant: GM GLOBAL TECHNOLOGY OPERATIONS LLC, Detroit, MI (US)

(72) Inventors: Sherman H. Zeng, Troy, MI (US); Xingcheng Xiao, Troy, MI (US); Mei Cai, Bloomfield Hills, MI (US); Scott W. Lananna, Detroit, MI (US); Yangbing Zeng, Troy, MI (US)

(73) Assignee: GM GLOBAL TECHNOLOGY OPERATIONS LLC, Detroit, MI (US)

(21) Appl. No.: 17/386,745

(22) Filed: Jul. 28, 2021

(51) Int. Cl. H01M 10/659; H01M 10/6554; H01M 10/613; H01M 10/6551; H01M 10/625; H01M 50/204; H01M 50/249

(52) U.S. Cl. CPC H01M 10/659; H01M 10/6554; H01M 10/613; H01M 10/6551; H01M 10/625; H01M 50/204; H01M 50/249; H01M 2220/20

(57) ABSTRACT

A battery module includes a plurality of battery cells and a thermal energy storage member in thermal contact with the plurality of battery cells. The thermal energy storage member includes an adsorption chamber and an adsorbent material disposed within the adsorption chamber. The adsorbent material is configured to receive thermal energy generated by the plurality of battery cells during charging and discharge of the plurality of battery cells. The thermal energy received by the adsorbent material during charging and discharge of the plurality of battery cells regenerates the adsorbent material and transitions the adsorbent material from an energy released state, in which an adsorbate is physically adsorbed on surfaces of the adsorbent material, to an energy storage state, in which the adsorbent material is substantially free of the adsorbate.

The present disclosure relates to battery modules and, more particularly, to thermal management and control of battery modules.

A battery is a device that converts chemical energy into electrical energy by means of electrochemical reduction-oxidation (redox) reactions. In secondary or rechargeable batteries, these electrochemical reactions are reversible, which allows the batteries to undergo multiple charging and discharge cycles. Electric vehicles, including hybrid electric vehicles, are powered by electric motors or generators that, in turn, are typically powered by onboard rechargeable batteries. Such batteries typically include multiple individual battery cells arranged in series or parallel and positioned adjacent one another to form battery modules and battery packs that, when incorporated in a battery system of an electric vehicle, provide the vehicle with a combination of high voltage and high capacity.

Rechargeable batteries employed in electric vehicles may internally generate heat during charging and discharging and may be exposed to a wide range of ambient temperatures during the operating life of the vehicle. To optimize the performance and life of such batteries, it is beneficial to effectively and efficiently control the temperature of the battery cells so that exposure to excessively high and low temperatures is avoided. In addition, it may be desirable to store heat generated by the battery cells for subsequent use during cold-start conditions of the vehicle.

### SUMMARY

A battery module is disclosed that comprises a plurality of battery cells and a thermal energy storage member in thermal contact with the plurality of battery cells. The battery cells generate thermal energy during charging and discharge thereof. The thermal energy storage member includes an adsorption chamber and an adsorbent material disposed within the adsorption chamber. Thermal energy generated by the plurality of battery cells during charging or discharge thereof is transferred to the adsorbent material of the thermal energy storage member. The thermal energy transferred to the adsorbent material during charging or discharge of the plurality of battery cells regenerates the adsorbent material and transitions the adsorbent material from an energy released state, in which an adsorbate is physically adsorbed on surfaces of the adsorbent material, to an energy storage state, in which the adsorbent material is substantially free of the adsorbate.

The adsorbent material may exhibit an open microporous structure and may be at least one of a zeolite, silica gel, or activated carbon.

The adsorbent material may be: (i) in the form of a monolithic structure, (ii) in the form of a coating deposited on surfaces of a monolithic support structure, or (iii) in particulate form.

The adsorbate may comprise water.

The battery module may comprise a cooling plate including a cooling passage. The plurality of battery cells may be in thermal contact with the cooling plate. The cooling passage may be configured to receive a coolant during charging and discharge of the plurality of battery cells to transfer thermal energy away from the plurality of battery cells via thermal conduction.

The thermal energy storage member may include a heat transfer fin. The heat transfer fin may be made of a metal or a metal alloy. The heat transfer fin may be in thermal contact with the plurality of battery cells and with the cooling plate.

The thermal energy storage member may be disposed between and in thermal contact with two adjacent battery cells of the plurality of battery cells.

The thermal energy storage member may include a compression layer. The compression layer may be disposed between facing surfaces of the two adjacent battery cells of the plurality of battery cells. The compression layer may be configured to maintain contact pressure respectively between the facing surfaces of the two adjacent battery cells and opposite first and second sidewalls of the adsorption chamber.

During regeneration of the adsorbent material, the adsorbate may physically desorb from the surfaces of the adsorbent material and may be removed from the adsorption chamber via an outlet thereof. Physical desorption of the adsorbate from the surfaces of the adsorbent material consumes thermal energy and thereby transfers thermal energy away from the plurality of battery cells.

To selectively release thermal energy from the adsorbent material, an adsorbate-containing gaseous medium may be passed through the adsorption chamber and in physical contact with the adsorbent material such that the adsorbate physically adsorbs on the surfaces of the adsorbent material. Physical adsorption of the adsorbate on the surfaces of the adsorbent material may generate thermal energy. The generated thermal energy may be transferred to the plurality of battery cells via thermal conduction.

A thermal energy storage system for a battery module of an electric vehicle is disclosed. The system comprises a plurality of battery cells and a thermal energy storage member in thermal contact with the plurality of battery cells. The thermal energy storage member includes an adsorption chamber and an adsorbent material disposed within the adsorption chamber. The adsorption chamber includes an inlet in fluid communication with an outlet. An adsorbate storage chamber is configured to store an adsorbate in liquid form. A first conduit is in fluid communication with the adsorbate storage chamber and with the inlet of the adsorption chamber. The first conduit is configured to transfer a first adsorbate-containing gaseous medium from the adsorbate storage chamber to the inlet of the adsorption chamber. A second conduit is in fluid communication with the outlet of the adsorption chamber and with the adsorbate storage chamber. The second conduit is configured to transfer a second adsorbate-containing gaseous medium from the adsorption chamber to the adsorbate storage chamber. The adsorbent material is configured to transition from an energy released state, in which the adsorbate is physically adsorbed on surfaces of the adsorbent material, to an energy storage state, in which the adsorbent material is substantially free of the adsorbate.

The adsorbent material may exhibit an open microporous structure and may be at least one of a zeolite, silica gel, or activated carbon. The adsorbate may comprise water.

The adsorbate storage chamber may include a heat exchanger in thermal contact with the adsorbate stored therein. The heat exchanger may be configured to supply thermal energy to the adsorbate in the adsorbate storage chamber to vaporize at least a portion of the adsorbate in the adsorbate storage chamber. The heat exchanger may be configured to transfer thermal energy away from the second adsorbate-containing gaseous medium during regeneration of the adsorbent material to condense the adsorbate in the second adsorbate-containing gaseous medium to a liquid.

The thermal energy storage member may be disposed between and in thermal contact with two adjacent battery cells of the plurality of battery cells.

The plurality of battery cells may be in thermal contact with a cooling plate including a cooling passage configured to receive a coolant during charging and discharge of the plurality of battery cells to transfer thermal energy away from the plurality of battery cells via thermal conduction. The thermal energy storage member may include a heat transfer fin made of a metal or a metal alloy. The heat transfer fin may be in thermal contact with the two adjacent battery cells of the plurality of battery cells and with the cooling plate.

A method of storing thermal energy generated by a battery cell of a battery module is disclosed. The method comprises positioning a thermal energy storage member in thermal contact with a battery cell of a battery module. The thermal energy storage member includes an adsorption chamber and an adsorbent material disposed within the adsorption chamber. The adsorbent material is configured to transition from an energy released state, in which an adsorbate is physically adsorbed on surfaces of the adsorbent material, and an energy storage state, in which the adsorbent material is substantially free of the adsorbate. The battery cell of the battery module is charged or discharged such that thermal energy is generated by the battery cell and transferred via thermal conduction to the adsorbent material of the thermal energy storage member. When the adsorbent material is in the energy released state, the thermal energy transferred to the adsorbent material at least partially regenerates the adsorbent material and transitions the adsorbent material to the energy storage state by vaporizing the adsorbate and releasing the adsorbate from the surfaces of the adsorbent material.

Thermal energy may be selectively released from the adsorbent material by passing an adsorbate-containing gaseous medium in physical contact with the adsorbent material such that at least a portion of the adsorbate in the adsorbate-containing gaseous medium is adsorbed on the surfaces of the adsorbent material.

Adsorption of the adsorbate on the surfaces of the adsorbent material may generate thermal energy. The thermal energy generated during adsorption of the adsorbate on the surfaces of the adsorbent material may be transferred to the battery cell of the battery module by thermal conduction.

During regeneration of the adsorbent material, a second gaseous medium that is substantially free of the adsorbate may be passed through the adsorption chamber such that the vaporized adsorbate is mixed with the second gaseous medium, transferred away from the adsorbent material, and removed from the adsorption chamber along with the second gaseous medium.

The second gaseous medium may be transferred along with the vaporized adsorbate from the adsorption chamber to an adsorbate storage chamber. Thermal energy may be transferred away from the vaporized adsorbate in the adsorbate storage chamber to condense the vaporized adsorbate to a liquid.

The adsorbent material may exhibit an open microporous structure and may be at least one of a zeolite, silica gel, or activated carbon. The adsorbate may comprise water.

The above summary is not intended to represent every possible embodiment or every aspect of the present disclosure. Rather, the foregoing summary is intended to exemplify some of the novel aspects and features disclosed herein. The above features and advantages, and other features and advantages of the present disclosure, will be readily apparent from the following detailed description of representative embodiments and modes for carrying out the present disclosure when taken in connection with the accompanying drawings and the appended claims.

### BRIEF DESCRIPTION OF THE DRAWINGS

Illustrative embodiments will hereinafter be described in conjunction with the appended drawings, wherein like designations denote like elements, and wherein:

FIG. 1 is a schematic perspective view of a battery module for an electric power supply of an electric vehicle, the battery module including a plurality of battery cells and a thermal energy storage member disposed between a pair of adjacent battery cells.

FIG. 2 is a schematic perspective view of an electric vehicle including the battery module of FIG. 1.

FIG. 3 is a schematic side cross-sectional view of the thermal energy storage member of FIG. 1 disposed between a pair of adjacent battery cells.

FIG. 4 is a schematic side cross-sectional view of the thermal energy storage member of FIG. 3 taken along line 4-4 of FIG. 3.

The present disclosure is susceptible to modifications and alternative forms, with representative embodiments shown by way of example in the drawings and described in detail below. Inventive aspects of this disclosure are not limited to the particular forms disclosed. Rather, the present disclosure is intended to cover modifications, equivalents, combinations, and alternatives falling within the scope of the disclosure as defined by the appended claims.

### DETAILED DESCRIPTION

The thermal energy storage member described herein is configured to store and release thermal energy generated by battery cells of a battery module using the principles of adsorption heat storage, also referred to as thermochemical heat storage. The thermal energy storage member includes an adsorbent material having an open microporous structure. When the adsorbent material of the thermal energy storage member is in an energy released state, surfaces of the adsorbent material are saturated with an adsorbate. To transition the adsorbent material from the energy released state to an energy storage state, thermal energy generated by the battery cells of the battery module is transferred via thermal conduction to the adsorbent material to vaporize and remove the adsorbate from the adsorbent material. Desorption of the adsorbate from the adsorbent material is an endothermic process, which removes heat from the system and helps cool the battery cells. When the adsorbent material is dry, thermal energy is stored by the adsorbent material in the form of adsorption potential energy between the adsorbate and the adsorbent material. When the adsorbent material is in the energy storage state, thermal energy may be selectively released or recovered from the adsorbent material by allowing the adsorbate to adsorb onto the surfaces of the adsorbent material. Physical adsorption of the adsorbate on the surfaces of the adsorbent material is an exothermic process, and the thermal energy released during the adsorption process may be transferred to the battery cells of the battery module, for example, in cold ambient conditions to raise the temperature of the battery cells to a desirable operating temperature.

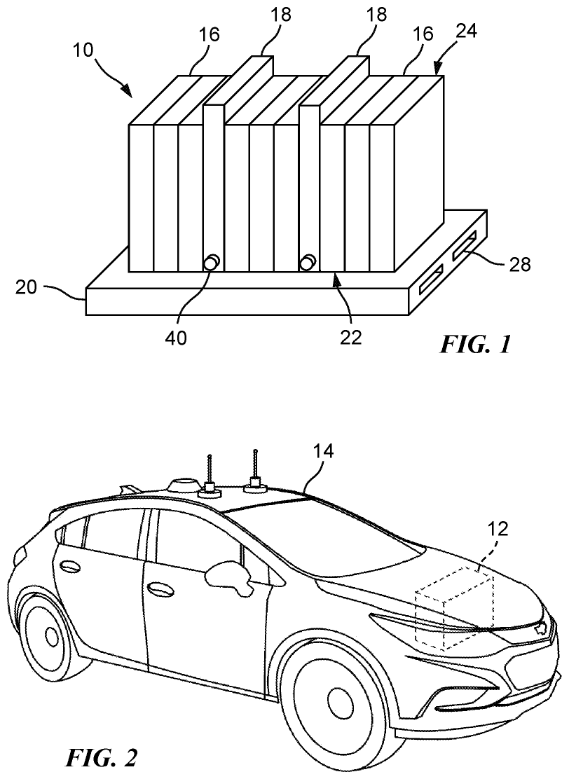

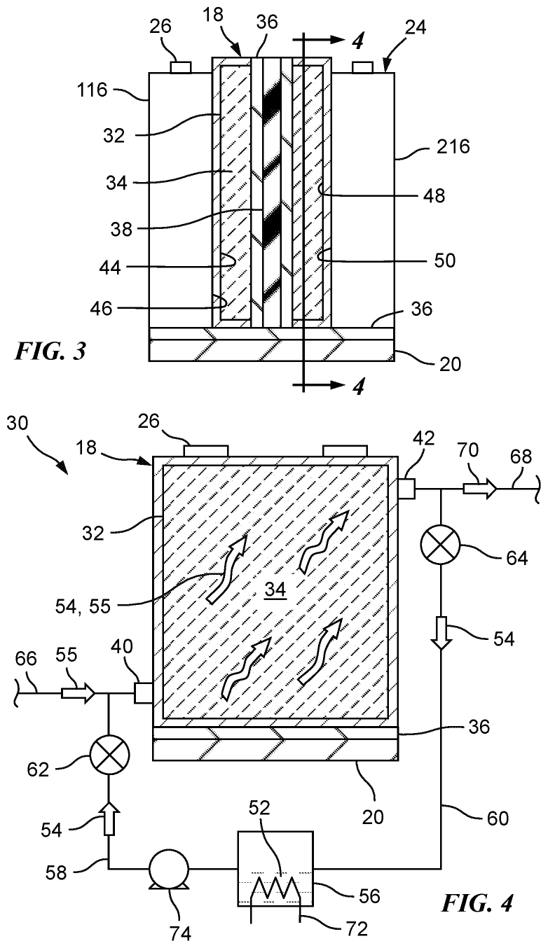

FIG. 1 depicts a battery module 10 that may be used in an electric power supply 12 of an electric vehicle 14, as shown in FIG. 2. The battery module 10 includes a plurality of battery cells 16 positioned adjacent one another and at least one thermal energy storage member 18 disposed between adjacent battery cells 16. In practice, the battery module 10 may be part of a battery management system (not shown) of the electric vehicle 14 and may be positioned in thermal contact with a cooling plate 20 and housed within a battery case (not shown). Each battery cell 16 has a lower end 22 adjacent the cooling plate 20 and an opposite upper end 24 that extends away from the cooling plate 20. Each battery cell 16 may include a pair of positive and negative electrode terminals 26 (FIGS. 3 and 4), which may allow the battery cells 16 of the battery module 10 to be connected in a series or parallel arrangement. The positive and negative electrode terminals 26 may be located at the upper end 24 of each battery cell 16 (as shown in FIGS. 3 and 4), or the terminals 26 may extend from one of both sides of each battery cell 16, between the lower and upper ends 22, 24 thereof. In one form, the battery cells 16 may comprise lithium-ion battery cells. For example, the battery cells 16 may comprise prismatic pouch-type or can-type lithium-ion battery cells.

The cooling plate 20 is configured to transfer thermal energy (i.e., heat) away from the battery cells 16 of the battery module 10 and may include one or more cooling passages 28 extending therethrough. During cooling of the battery cells 16, a coolant may be passed through the cooling passages 28 in the cooling plate 20 to transfer thermal energy away from the battery cells 16 via thermal conduction. The cooling plate 20 may be made of metal or a metal alloy having high thermal conductivity, e.g., aluminum (Al), copper (Cu), or an alloy of aluminum and/or copper.

Referring now to FIGS. 3 and 4, the thermal energy storage member 18 is configured to help control the temperature of the battery cells 16 of the battery module 10 and may be part of a thermal energy storage system 30 onboard the electric vehicle 14. As shown in FIG. 3, in the battery module 10, the thermal energy storage member 18 may be sandwiched between a pair of adjacent first and second battery cells 116, 216. The thermal energy storage member 18 may be configured to transfer thermal energy away from the battery cells 16, 116, 216 during charging and discharge of the battery cells 16, 116, 216 and to supply thermal energy to the battery cells 16, 116, 216 under cold ambient conditions to help raise the temperature of the battery cells 16, 116, 216 and the battery module 10 to a desirable operating temperature.

The thermal energy storage member 18 defines an adsorption chamber 32 and includes an adsorbent material 34 disposed in the adsorption chamber 32. The thermal energy storage member 18 optionally may include one or more heat transfer fins 36 and/or a compression layer 38.

The adsorption chamber 32 of the thermal energy storage member 18 is configured to contain the adsorbent material 34 and to facilitate intimate physical contact between the adsorbent material 34 and a gaseous medium flowing through the adsorption chamber 32. In addition, the adsorption chamber 32 is configured to position the adsorbent material 34 in thermal contact with the adjacent first and second battery cells 116, 216 to allow for efficient transfer of thermal energy therebetween. The adsorption chamber 32 includes an inlet 40 and an outlet 42 in fluid communication with the inlet 40. During operation of the thermal energy storage system 30, the gaseous medium is received in the inlet 40 of the adsorption chamber 32 and is discharged from the outlet 42 of the adsorption chamber 32. The adsorption chamber 32 of the thermal energy storage member 18 may be at least partially defined by a first wall 44 disposed adjacent a facing surface 46 of the first battery cell 116 and an opposite second wall 48 disposed adjacent a facing surface 50 of the second battery cell 216. In aspects, the first wall 44 of the adsorption chamber 32 may be in direct physical contact with the first battery cell 116 and the second wall 48 may be in direct physical contact with the second battery cell 216.

The adsorbent material 34 is configured to transition between an energy released state, in which surfaces of the adsorbent material 34 are saturated with an adsorbate 52 (FIG. 4), and an energy storage state, in which the adsorbent material 34 is substantially free of the adsorbate 52. When the adsorbent material 34 is in the energy storage state, thermal energy is stored by the adsorbent material 34 in the form of adsorption potential energy between the adsorbate 52 and the adsorbent material 34. This stored thermal energy may be selectively released from the adsorbent material 34 by passing a first gaseous medium 54 containing the adsorbate 52 in direct physical contact with the adsorbent material 34 such that the adsorbate 52 in the first gaseous medium 54 adsorbs onto the surfaces of the adsorbent material 34. To regenerate the adsorbent material 34, thermal energy is applied to the adsorbent material 34 to vaporize the adsorbate 52 and desorb the adsorbate 52 from the surfaces of the adsorbent material 34. Thermal energy may be applied to the adsorbent material 34, for example, from waste heat generated by the battery module 10 during charging and discharge of the battery cells 16, 116, 216 of the battery module 10. During regeneration of the adsorbent material 34, a second gaseous medium 55 may be passed through the adsorption chamber 32 to facilitate removal of desorbed adsorbate 52 vapors from the adsorption chamber 32. The second gaseous medium 55 may be substantially free of the adsorbate 52.

In aspects, the adsorbent material 34 may provide the battery module 10 with resistance to thermal runaway conditions, for example, by inhibiting heat transfer between and among the battery cells 16, 116, 216 of the battery module 10.

The adsorbent material 34 may be made of a microporous material having a high surface area, an open microporous structure (pore sizes less than 2 nanometers), a high adsorption capacity for the adsorbate 52, and a high adsorption enthalpy with respect to the adsorbate 52. In aspects, the adsorbate 52 may comprise water and the adsorbent material 34 may comprise a hydrophilic crystalline aluminosilicate zeolite, aluminophosphate (AlPO) zeolite, silicoaluminophosphate (SAPO) zeolite, silica gel, activated alumina, and/or activated carbon.

The adsorbent material 34 may have pores with pore openings larger than the ionic radius of water (H₂O), i.e., larger than about 2.75 angstroms, to allow molecules of the adsorbate 52 to infiltrate the pores of the adsorbent material 34 during the adsorption process (release of thermal energy from the adsorbent material 34). For example, the adsorbent material 34 may have pore openings with widths or diameters greater than 3 angstroms.

Zeolite materials may be categorized based upon the crystalline structure of their corner-sharing network of tetrahedrally coordinated atoms or T-atoms (e.g., Si and Al). Zeolite structures are typically described or defined by reference to a framework type code consisting of three capital letters and assigned by the International Zeolite Association (“IZA”). A listing of framework type codes assigned by the IZA can be found in the Atlas of Zeolite Framework Types, Sixth Revised Edition, Elsevier (2007). The hydrophilicity of zeolite materials is related to the ratio of silica (Si) to aluminum (Al) in their framework structures, with the hydrophilicity of the zeolite material increasing as the Al content in the zeolite framework increases, and vice versa. In aspects, the adsorbent material 34 may comprise a hydrophilic zeolite material having a silica-to-aluminum (Si/Al) ratio of less than 5, less than 2, or about one. In addition, the hydrophilicity of zeolite materials may be dependent on their framework type. Hydrophilic zeolite frameworks having Si/Al ratios of less than 5 include: LTA and FAU.

The adsorbent material 34 may be in the form of a monolithic structure or may be in the form of a coating or layer deposited on surfaces of a monolithic support structure. In aspects, the adsorbent material 34 may be in particulate form. In aspects where the adsorbent material 34 is in particulate form, the adsorption chamber 32 may include a packed bed of particles of the adsorbent material 34.

The adsorbate 52 may comprise water and may be mixed with one or more substances (e.g., antifreeze) formulated to lower the freezing point of the adsorbate 52, e.g., to prevent the adsorbate 52 from freezing. Substances that may be mixed with the adsorbate 52 include alcohols, e.g., ethanol, methanol, ethylene glycol, and/or propylene glycol. In aspects, the adsorbate 52 may consist essentially of water.

The heat transfer fins 36 may be in thermal contact with the cooling plate 20 and may be configured to facilitate thermal energy transfer away from the battery cells 16, 116, 216 and the battery module 10. In aspects, at least a portion of one or more of the heat transfer fins 36 may be in direct physical contact with the cooling plate 20. Like the cooling plate 20, the heat transfer fins 36 may be made of metal or a metal alloy having high thermal conductivity, e.g., aluminum (Al), copper (Cu), or an alloy of aluminum and/or copper.

The compression layer 38 may be configured to compensate for expansion, contraction, and other physical changes in shape that may be experienced by the battery cells 16, 116, 216 of the battery module 10 during the operating life of the electric vehicle 14. The compression layer 38 may help maintain contact pressure between the facing surfaces 46, 50 of the first and second battery cells 116, 216 and the first and second walls 44, 48 of the adsorption chamber 32 and between the heat transfer fins 36 and the adsorbent material 34 and/or the adsorption chamber 32. The compression layer 38 may be made of a dielectric foam, e.g., a polyurethane foam.

As shown in FIG. 4, in practice, the thermal energy storage system 30 for the battery module 10 of the electric vehicle 14 may include an adsorbate storage chamber 56, a first conduit 58 through which an adsorbate-containing first gaseous medium 54 can flow from the adsorbate storage chamber 56 to the inlet 40 of the adsorption chamber 32, a second conduit 60 through which the first gaseous medium 54 can flow from the outlet 42 of the adsorption chamber 32 to the adsorbate storage chamber 56, and a pair of first and second control valves 62, 64 that respectively control the flow of the first gaseous medium 54 from and to the adsorbate storage chamber 56. The thermal energy storage system 30 may include a third conduit 66 configured to provide a second gaseous medium 55 substantially free of the adsorbate 52 to the inlet 40 of the adsorption chamber 32 when the first control valve 62 is closed during recharge of the adsorbent material 34. The adsorbate storage chamber 56 may include a heat exchanger 72 configured to supply thermal energy (heat) to the adsorbate 52 to vaporize the adsorbate 52 prior to introducing the vaporized adsorbate 52 into the first gaseous medium 54. When the adsorbent material 34 is being regenerated, the heat exchanger 72 may be configured to transfer thermal energy away from the incoming adsorbate-containing first gaseous medium 54 to condense the adsorbate 52 to liquid form. One or more pumps 74 may be positioned along the first, second, third, or fourth conduits 58, 60, 66, 68 to facilitate fluid flow therethrough and through the adsorption chamber 32.

The first and/or second gaseous mediums 54, 55 may comprise a carrier gas and, during release of thermal energy from the adsorbent material 34, the first gaseous medium 54 also may comprise the adsorbate 52. The carrier gas may be air (i.e., about 78% nitrogen and 21% oxygen, by volume) and/or an inert gas (e.g., nitrogen and/or argon). The adsorbate 52 may be present in the first gaseous medium 54 in the form of a gas, a vapor, and/or as liquid droplets or particles suspended in the carrier gas.

In aspects, the thermal energy storage system 30 may be a closed system, meaning that the system 30 may be entirely enclosed and may not receive an influent gas stream and may not discharge an effluent gas stream to the ambient environment. In aspects where the thermal energy storage system 30 is a closed system, the thermal energy storage system 30 may be operated at subatmospheric pressures (e.g., less than 1 Atm), for example, to lower the temperature at which the adsorbate 52 may be evaporated from or desorbed from the adsorbent material 34 during regeneration. In other aspects, the thermal energy storage system 30 may be an open system, meaning that the system 30 may receive an influent gas stream (e.g., the second gaseous medium 55) and may discharge an effluent gas stream to the ambient environment. For example, in such case, the thermal energy storage system 30 may include a fourth conduit 68 from which an effluent gas stream 70 may be discharged, for example, to an ambient environment, when the second control valve 64 is closed during discharge of the adsorbent material 34.

These and other benefits will be readily appreciated by those of ordinary skill in the art in view of the forgoing disclosure. While some of the best modes and other embodiments have been described in detail, various alternative designs and embodiments exist for practicing the present teachings defined in the appended claims. Those skilled in the art will recognize that modifications may be made to the disclosed embodiments without departing from the scope of the present disclosure. Moreover, the present concepts expressly include combinations and sub-combinations of the described elements and features. The detailed description and the drawings are supportive and descriptive of the present teachings, with the scope of the present teachings defined solely by the claims.

What is claimed is:

1. A battery module comprising:
a plurality of battery cells that generate thermal energy during charging and discharge thereof; and
a thermal energy storage member in thermal contact with the plurality of battery cells, the thermal energy storage member including:
an adsorption chamber, and
an adsorbent material disposed within the adsorption chamber,
wherein thermal energy generated by the plurality of battery cells during charging or discharge thereof is transferred to the adsorbent material of the thermal energy storage member,
wherein the thermal energy transferred to the adsorbent material during charging or discharge of the plurality of battery cells regenerates the adsorbent material and transitions the adsorbent material from an energy released state, in which an adsorbate is physically adsorbed on surfaces of the adsorbent material, to an energy storage state, in which the adsorbent material is substantially free of the adsorbate.

2. The battery module of claim 1 wherein the adsorbent material exhibits an open microporous structure and is at least one of a zeolite, silica gel, or activated carbon.

3. The battery module of claim 1 wherein the adsorbent material is: (i) in the form of a monolithic structure, (ii) in the form of a coating deposited on surfaces of a monolithic support structure, or (iii) in particulate form.

4. The battery module of claim 1 wherein the adsorbate comprises water.

5. The battery module of claim 1 further comprising:
a cooling plate including a cooling passage,
wherein the plurality of battery cells are in thermal contact with the cooling plate, and
wherein the cooling passage is configured to receive a coolant during charging and discharge of the plurality of battery cells to transfer thermal energy away from the plurality of battery cells via thermal conduction.

6. The battery module of claim 5 wherein the thermal energy storage member includes a heat transfer fin, wherein the heat transfer fin is made of a metal or a metal alloy, and wherein the heat transfer fin is in thermal contact with the plurality of battery cells and with the cooling plate.

7. The battery module of claim 1 wherein the thermal energy storage member is disposed between and in thermal contact with two adjacent battery cells of the plurality of battery cells.

8. The battery module of claim 7 wherein the thermal energy storage member includes a compression layer, wherein the compression layer is disposed between facing surfaces of the two adjacent battery cells of the plurality of battery cells, and wherein the compression layer is configured to maintain contact pressure respectively between the facing surfaces of the two adjacent battery cells and opposite first and second sidewalls of the adsorption chamber.

9. The battery module of claim 1 wherein, during regeneration of the adsorbent material, the adsorbate physically desorbs from the surfaces of the adsorbent material and is removed from the adsorption chamber via an outlet thereof, wherein physical desorption of the adsorbate from the surfaces of the adsorbent material consumes thermal energy and thereby transfers thermal energy away from the plurality of battery cells.

10. The battery module of claim 1 wherein, to selectively release thermal energy from the adsorbent material, an adsorbate-containing gaseous medium is passed through the adsorption chamber and in physical contact with the adsorbent material such that the adsorbate physically adsorbs on the surfaces of the adsorbent material, wherein physical adsorption of the adsorbate on the surfaces of the adsorbent material generates thermal energy, and wherein the generated thermal energy is transferred to the plurality of battery cells via thermal conduction.

11. A thermal energy storage system for a battery module of an electric vehicle, the system comprising:
a plurality of battery cells; and
a thermal energy storage member in thermal contact with the plurality of battery cells, the thermal energy storage member including:
an adsorption chamber including an inlet in fluid communication with an outlet, and
an adsorbent material disposed within the adsorption chamber,
an adsorbate storage chamber configured to store an adsorbate in liquid form;
a first conduit in fluid communication with the adsorbate storage chamber and with the inlet of the adsorption chamber, the first conduit being configured to transfer a first adsorbate-containing gaseous medium from the adsorbate storage chamber to the inlet of the adsorption chamber; and
a second conduit in fluid communication with the outlet of the adsorption chamber and with the adsorbate storage chamber, the second conduit being configured to transfer a second adsorbate-containing gaseous medium from the adsorption chamber to the adsorbate storage chamber,
wherein the adsorbent material is configured to transition from an energy released state, in which the adsorbate is physically adsorbed on surfaces of the adsorbent material, to an energy storage state, in which the adsorbent material is substantially free of the adsorbate.

12. The system of claim 11 wherein the adsorbent material exhibits an open microporous structure and is at least one of a zeolite, silica gel, or activated carbon, and wherein the adsorbate comprises water.

13. The system of claim 11 wherein the adsorbate storage chamber includes a heat exchanger in thermal contact with the adsorbate stored therein, wherein the heat exchanger is configured to transfer thermal energy to the adsorbate in the adsorbate storage chamber to vaporize at least a portion of the adsorbate in the adsorbate storage chamber, and wherein the heat exchanger is configured to transfer thermal energy away from the second adsorbate-containing gaseous medium during regeneration of the adsorbent material to condense the adsorbate in the second adsorbate-containing gaseous medium to a liquid.

14. The system of claim 11 wherein the thermal energy storage member is disposed between and in thermal contact with two adjacent battery cells of the plurality of battery cells.

15. The system of claim 14 wherein the plurality of battery cells are in thermal contact with a cooling plate including a cooling passage configured to receive a coolant during charging and discharge of the plurality of battery cells to transfer thermal energy away from the plurality of battery cells via thermal conduction, wherein the thermal energy storage member includes a heat transfer fin made of a metal or a metal alloy, and wherein the heat transfer fin is in thermal contact with the two adjacent battery cells of the plurality of battery cells and with the cooling plate.

16. A method of storing thermal energy generated by a battery cell of a battery module, the method comprising:
positioning a thermal energy storage member in thermal contact with a battery cell of a battery module, the thermal energy storage member including an adsorption chamber and an adsorbent material disposed within the adsorption chamber, the adsorbent material being configured to transition from an energy released state, in which an adsorbate is physically adsorbed on surfaces of the adsorbent material, and an energy storage state, in which the adsorbent material is substantially free of the adsorbate;
charging or discharging the battery cell of the battery module such that thermal energy is generated by the battery cell and transferred via thermal conduction to the adsorbent material of the thermal energy storage member,
wherein, when the adsorbent material is in the energy released state, the thermal energy transferred to the adsorbent material at least partially regenerates the adsorbent material and transitions the adsorbent material to the energy storage state by vaporizing the adsorbate and releasing the adsorbate from the surfaces of the adsorbent material.

17. The method of claim 16 further comprising:
selectively releasing thermal energy from the adsorbent material by passing an adsorbate-containing gaseous medium in physical contact with the adsorbent material such that at least a portion of the adsorbate in the adsorbate-containing gaseous medium is adsorbed on the surfaces of the adsorbent material,
wherein adsorption of the adsorbate on the surfaces of the adsorbent material generates thermal energy, and
wherein the thermal energy generated during adsorption of the adsorbate on the surfaces of the adsorbent material is transferred to the battery cell of the battery module by thermal conduction.

18. The method of claim 16 further comprising:
during regeneration of the adsorbent material, passing a second gaseous medium that is substantially free of the adsorbate through the adsorption chamber such that the vaporized adsorbate is mixed with the second gaseous medium, transferred away from the adsorbent material, and removed from the adsorption chamber along with the second gaseous medium.

19. The method of claim 18 further comprising:
transferring the second gaseous medium along with the vaporized adsorbate from the adsorption chamber to an adsorbate storage chamber; and
transferring thermal energy away from the vaporized adsorbate in the adsorbate storage chamber to condense the vaporized adsorbate to a liquid.

20. The method of claim 16 wherein the adsorbent material exhibits an open microporous structure and is at least one of a zeolite, silica gel, or activated carbon, and wherein the adsorbate comprises water.
